(19) United States
(12) Patent Application Publication
(10) Pub. No.: US 2008/0026244 A1
(43) Pub. Date: Jan. 31, 2008

(54) Rubber Composition Exhibiting Improved Adhesion to a Metal Reinforcement

(76) Inventors: Fanny Barbotin, Clermont-Ferrand (FR); Jean-Luc Cabioch, Chateaugay (FR); Marc Greiveldinger, Chatel-Guyon (FR); Gerard Pouzet, Ceyrat (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/579,228

(22) PCT Filed: Apr. 29, 2005
(86) PCT No.: PCT/EP05/04613

§ 371 Date: Oct. 30, 2006

(30) Foreign Application Priority Data
Apr. 30, 2004 (FR) 04/04603

(51) Int. Cl. C08L 9/00; B32B 15/06; C08K 5/098

(52) U.S. Cl. 428/625; 524/398; 524/571; 524/574; 524/575.5

(57) ABSTRACT

Rubber composition usable for the manufacture of metallic rubberised fabrics and capable of adhering to a metallic reinforcing member, comprising a diene elastomer, a reinforcing filler, a cross-linking system and an adhesion promoter, said adhesion promoter comprising at least one lanthanide compound, preferably an organolanthanide. Metal/rubber composite comprising such a composition and its use for the manufacture or the reinforcement of ground contact systems of motor vehicles such as tires. Ground contact systems and semi-finished rubber products, in particular tires, comprising such a composite. The lanthanide compound imparts to the composition and to the composite improved adhesive properties after thermal ageing, in particular in humid conditions. It may be used alone or in combination with a cobalt compound, in particular in carcass or crown reinforcements of passenger-vehicle or heavy-vehicle tires.

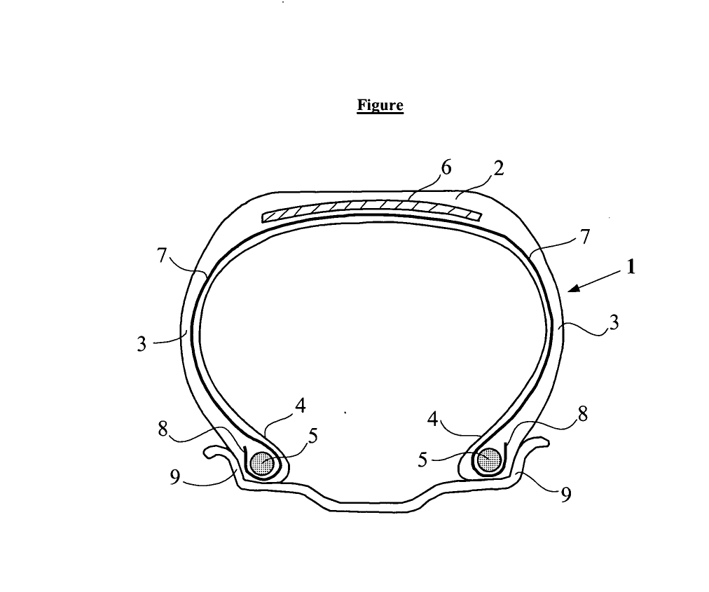

The present invention relates to rubber compositions and to metal/rubber composites, in particular to compositions and composites usable for the manufacture of ground contact systems of motor vehicles, in particular tires.

It relates more particularly to the adhesive systems providing the bond between the metal and the rubber in such composites.

Metal/rubber composites, in particular for tires, are well-known, and are generally formed of a sulfur-cross-linkable diene rubber matrix comprising metallic reinforcement elements (or “reinforcing members”), generally in the form of wire(s) or assemblies of wires.

It is known that these composites, which are subject to very great stresses during rolling of the tires, in particular to repeated compression, flexing or variations in curvature, must satisfy a large number of technical criteria, which are sometimes contradictory, such as uniformity, flexibility, endurance under bending and in compression, tensile strength, resistance to wear and to corrosion, and keep these performances at a very high level for as long as possible.

It will readily be understood that the adhesive interphase between rubber and metal plays a leading part in the extended service life of these types of performance. To illustrate this, it may be recalled in particular that the traditional process for joining the rubber compositions to carbon steel consists of coating the surface of the steel with brass (copper/zinc alloy), the bond between the steel and the rubber matrix being provided by sulfurisation of the brass during vulcanization; to improve adhesion, furthermore frequently, organic salts or cobalt complexes are used as adhesion-promoting additives in said rubber compositions (see by way of example patent specifications FR-A-2 501 700 or U.S. Pat. No. 4,549,594; U.S. Pat. No. 4,933,385; U.S. Pat. No. 5,624,764).

Now, it is known that the adhesion between the carbon steel and the rubber matrix is liable to weaken over time, owing to the gradual evolution of the sulfides under the action of the various stresses encountered, in particular mechanical and/or thermal stresses, the above degradation process being able to be accelerated in the presence of humidity. On the other hand, the use of cobalt compounds, in addition to the fact that it significantly increases the cost of the rubber compositions, increases the sensitivity of the latter to oxidation and ageing.

Continuing their research, the Applicants have discovered novel adhesion-promoting additives which are distinctly less expensive than cobalt compounds which unexpectedly also make it possible to improve the adhesion performance of the rubber compositions with regard to metallic reinforcing members, particularly after thermal ageing, in particular in humid conditions. As such, they may advantageously replace all or some of the aforementioned cobalt compounds.

Consequently, a first subject of the invention is a rubber composition usable for manufacturing a metal/rubber composite and capable of adhering to a metallic reinforcing member, comprising at least one diene elastomer, a reinforcing filler, a cross-linking system and an adhesion promoter, characterized in that said adhesion promoter comprises a lanthanide compound.

The invention also relates to the use of such a lanthanide compound as adhesion promoter with respect to a metallic reinforcing member, in a diene rubber composition.

The invention also relates per se to a metal/rubber adhesion-promoting system, characterized in that it comprises a lanthanide compound and a cobalt compound in combination.

The subject of the invention is also a metal/rubber composite comprising a diene rubber composition according to the invention and at least one metallic reinforcing member adhering to said rubber composition.

This metal/rubber composite is characterized by an improved metal/rubber adhesive interphase, offering a level of adhesion which is at least as good in the initial state (directly after curing), compared with the prior known solutions, furthermore with distinctly improved performances after ageing of thermal type, in particular in humid conditions.

The invention also relates to the use of a composite of this type for the manufacture or reinforcement of ground contact systems for motor vehicles, such as tires, internal safety supports for tires, wheels, rubber springs, elastomeric joints and other suspension and anti-vibration elements, or alternatively semi-finished products made of rubber intended for such ground contact systems.

The composite according to the invention is particularly intended for the reinforcement armatures of the crown, the carcass or the bead zone of tires intended to be fitted on motor vehicles of the type passenger-car, SUV (“Sport Utility Vehicles”), two-wheeled vehicles (in particular motorcycles), aircraft, and also industrial vehicles selected from among vans, heavy vehicles—that is to say subway trains, buses, road transport machinery (lorries, tractors, trailers), off-road vehicles such as agricultural machinery or construction machinery, and other transport or handling vehicles.

The invention also relates to the ground contact systems and the semi-finished rubber products themselves, when they comprise a composite according to the invention. The invention shows all its advantages in particular in carcass reinforcements for tires for heavy vehicles, of which it is nowadays expected, due to the technical progress in retreading, that they be capable of lasting for more than a million kilometres, and also in crown reinforcements for tires intended both for passenger vehicles and for industrial vehicles. The longevity of the tires can thus be substantially improved, in particular that of the tires subjected to particularly severe running conditions, in particular in a humid, corrosive atmosphere.

The invention and its advantages will be readily understood in the light of the description and examples of embodiment which follow, and of the diagrammatic figure relating to these examples, which shows a radial section through a tire having a radial carcass reinforcement.

I. Measurements and Tests

I-1. Dynamometric Measurements

As far as the metallic reinforcing members (wires or cables) are concerned, the measurements of breaking load Fm (maximum load in N), of tensile strength Rm (in MPa) and elongation at break At (total elongation in %) are taken under tension in accordance with Standard ISO 6892 of 1984. As far as the rubber compositions are concerned, the modulus measurements are carried out under tension, unless expressly indicated otherwise in accordance with Standard ASTM D 412 of 1998 (test piece “C”); the true secant moduli, that is to say reduced to the real section of the test piece at 10% elongation, denoted E10 and expressed in MPa (normal conditions of temperature and humidity in accordance with Standard ASTM D 1349 of 1999), are measured in a second elongation (i.e. after an accommodation cycle).

I-2. Adhesion Test

The quality of the bond between the metallic reinforcing member and the rubber matrix is assessed by a test in which the force, referred to as tearing force, necessary to extract the metallic reinforcing member from the rubber matrix, in the vulcanized state, is measured.

The metal/rubber composite used in this test is a block of rubber composition, formed of two plates of dimensions 300 mm by 150 mm (millimetres) and of a thickness of 3.5 mm, which are applied to one another before curing; the thickness of the resulting block is then 7 mm. It is during the building of this block that the reinforcing members, for example twelve in number, are imprisoned between the two uncured plates; only one given length of reinforcing member, for example 12.5 mm, is left free to come into contact with the rubber composition to which this length of reinforcing member will become joined during curing; the rest of the length of the reinforcing members is isolated from the rubber composition (for example using a plastic or metallic film) to prevent any adhesion outside the given contact zone. Each reinforcing member passes right through the block of rubber, at least one of its free ends being kept of sufficient length (at least 5 cm, for example between 5 and 10 cm) to permit later tensile loading of the reinforcing member.

The block comprising the twelve reinforcing members is then placed in a suitable mould and then cured, unless indicated otherwise, for 40 minutes at 150° C., at a pressure of approximately 11 bar.

After curing the composite, if applicable, the accelerated ageing conditions below are applied, which make it possible to determine the resistance of the samples to the combined action of heat and/or humidity, depending on the case:
either what is called “thermal” ageing: the blocks of rubber are placed in an oven at a temperature of 135° C. for 16 hours;
or what is called “thermal and humid” ageing: the blocks of rubber are placed in an oven at a temperature of 105° C., for 16 hours and at a relative humidity of 100%.

On emerging from the curing and any subsequent ageing, the block is cut into test pieces acting as samples, each containing a reinforcing member which is drawn out of the block of rubber, using a traction machine; the traction rate is 50 mm/min; thus the adhesion is characterized by the force necessary to tear the reinforcing member from the test piece, at a temperature of 20° C.; the tearing force (Fa) represents the average of the 12 measurements corresponding to the 12 reinforcing members of the composite.

### II. DETAILED DESCRIPTION OF THE INVENTION

The metal/rubber composite of the invention, usable for manufacturing or reinforcing ground contact systems of motor vehicles such as for example tires, comprises at least one composition or rubber matrix, which itself is a subject of the invention, and a metallic reinforcing member to which it is capable of adhering, both being described in detail below.

In the present description, unless expressly indicated otherwise, all the percentages (%) indicated are mass %.

II-1. Rubber Composition

The composition of the invention is an elastomeric composition based on (i.e. comprising the mixture or the reaction product) at least one diene elastomer, a reinforcing filler, a cross-linking system and an adhesion promoter.

Its novel and essential characteristic is that said adhesion promoter is formed, in its entirety or in part, of a lanthanide compound.

A) Diene Elastomer

“Diene” elastomer (or less specifically rubber) is understood to mean, in known manner, an elastomer resulting at least in part (i.e. a homopolymer or a copolymer) from diene monomers (monomers bearing two double carbon-carbon bonds, whether conjugated or not).

The diene elastomers, in known manner, may be classed in two categories: those referred to as “essentially unsaturated” and those referred to as “essentially saturated”. In general, “essentially unsaturated” diene elastomer is understood here to mean a diene elastomer resulting at least in part from conjugated diene monomers, having a content of members or units of diene origin (conjugated dienes) which is greater than 15% (mol %). Thus, for example, diene elastomers such as butyl rubbers or copolymers of dienes and of alpha-olefins of the EPDM type do not fall within the preceding definition, and may in particular be described as “essentially saturated” diene elastomers (low or very low content of units of diene origin which is always less than 15%). Within the category of “essentially unsaturated” diene elastomers, “highly unsaturated” diene elastomer is understood to mean in particular a diene elastomer having a content of units of diene origin (conjugated dienes) which is greater than 50%.

These definitions being given, the following are understood more particularly to be meant by “diene elastomer capable of being used in the compositions according to the invention”:
(a)—any homopolymer obtained by polymerisation of a conjugated diene monomer, preferably having 4 to 12 carbon atoms;
(b)—any copolymer obtained by copolymerisation of one or more conjugated dienes together or with one or more vinyl-aromatic compounds preferably having 8 to 20 carbon atoms;
(c)—a ternary copolymer obtained by copolymerisation of ethylene, of an α-olefin preferably having 3 to 6 carbon atoms with a non-conjugated diene monomer preferably having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene;
(d)—a copolymer of isobutene and isoprene (butyl rubber), and also the halogenated, in particular chlorinated or brominated, versions of this type of copolymer.

Although it applies to any type of diene elastomer, the person skilled in the art of tires will understand that the present invention is used first and foremost with essentially unsaturated diene elastomers, in particular those of type (a) or (b) above.

More preferably, the diene elastomer is selected from the group consisting of polybutadienes (BR), natural rubber (NR), synthetic polyisoprenes (IR), the various butadiene copolymers, the various isoprene copolymers and mixtures of these elastomers. Such copolymers are more preferably selected from the group consisting of butadiene/styrene copolymers (SBR), the latter being prepared by emulsion polymerisation (ESBR) or solution polymerisation (SSBR), isoprene/butadiene copolymers (BIR), isoprene/styrene copolymers (SIR) and isoprene/butadiene/styrene copolymers (SBIR).

Of the polybutadienes, in particular those having a content of -1,2 units of between 4% and 80% or those having a content of cis-1,4 greater than 80% are suitable. Of the synthetic polyisoprenes, in particular cis-1,4-polyisoprenes, preferably those having an amount of cis-1,4 bonds greater than 90%, are suitable. Of the butadiene or isoprene copolymers, these are understood to be in particular the copolymers obtained by copolymerisation of at least one of these two monomers with one or more vinyl-aromatic compounds having from 8 to 20 carbon atoms. Suitable vinyl-aromatic compounds are, for example, styrene, ortho-, meta- and para-methylstyrene, the commercial mixture “vinyltoluene”, para-tert. butylstyrene, methoxystyrenes, chlorostyrenes, vinylmesitylene, divinylbenzene and vinylnaphthalene. The copolymers may contain between 99% and 20% by weight of diene units and between 1% and 80% by weight of vinyl-aromatic units.

The composites according to the invention are preferably intended for tires, in particular for the carcass reinforcements of tires for industrial vehicles such as vans or heavy vehicles, and for crown reinforcements for tires intended both for passenger vehicles and for industrial vehicles.

In that case, preferably, at least one isoprene elastomer, that is to say, in known manner, an isoprene homopolymer or copolymer, in other words a diene elastomer selected from the group consisting of natural rubber (NR), synthetic polyisoprenes (IR), the various isoprene copolymers and mixtures of these elastomers, is used. The isoprene elastomer is preferably natural rubber, or a synthetic polyisoprene of the cis-1,4 type preferably having an amount of cis-1,4 bonds greater than 90%, more preferably still greater than 98%.

In a blend with the isoprene elastomer above, the rubber compositions may contain diene elastomers other than isoprene ones, in particular SBR and/or BR elastomers such as mentioned above, whether the isoprene elastomer be present in a majority proportion or not among all the diene elastomers used.

Thus, according to a specific embodiment of the invention, it is possible to use for example, in a blend with the isoprene elastomer, in particular with natural rubber, an SBR copolymer having a Tg (glass transition temperature, measured in accordance with ASTM D3418) of preferably between −70° C. and −10° C., whether it be prepared in emulsion (ESBR) or in solution (SSBR), in a proportion of 0 to 70 phr (parts by weight per hundred parts of elastomer), the rest (30 to 100 phr) being the isoprene elastomer. In that case, more particularly an SSBR is used. With said SBRs (SSBR or ESBR) there may also be associated a BR having preferably more than 90% of cis-1,4 bonds, said BR having a Tg preferably between −110° C. and −50° C.

The rubber matrix may contain a single or several diene elastomers, this or these possibly being used in association with any type of synthetic elastomer other than a diene one, or even with polymers other than elastomers, for example thermoplastic polymers.

B) Reinforcing Filler

Any type of reinforcing filler known for its ability to reinforce a rubber composition usable for the manufacture of tires may be used, for example an organic filler such as carbon black, or alternatively a reinforcing inorganic filler such as silica, with which a coupling agent is associated in known manner.

Preferably carbon black is used. Suitable carbon blacks are all the carbon blacks, particularly blacks of the type HAF, ISAF and SAF, conventionally used in tires (what are called tire-grade blacks). Of the latter, reference will more particularly be made to the reinforcing carbon blacks of series 100, 200 or 300 (ASTM grades), such as, for example, the blacks N115, N134, N234, N326, N330, N339, N347, N375, or alternatively, depending on the intended applications, the blacks of higher series (for example N660, N683, N772).

“Reinforcing inorganic filler” is to be understood here to mean any inorganic or mineral filler, whatever its colour and its origin (natural or synthetic), also referred to as “white” filler or sometimes “clear” filler in contrast to carbon black, which is capable, on its own, without any other means than an intermediate coupling agent, of reinforcing a rubber composition intended for the manufacturing of tires, in other words which is capable of replacing a conventional tire-grade carbon black in its reinforcement function; such a filler is generally characterized, in known manner, by the presence of hydroxyl (—OH) groups at its surface.

Suitable reinforcing inorganic fillers are in particular mineral fillers of siliceous type, in particular silica (SiO₂), or of aluminous type, in particular alumina (Al₂O₃). The silica used may be any reinforcing silica known to the person skilled in the art, in particular any precipitated or fumed silica having a BET surface area and a CTAB specific surface area both of which are less than 450 m²/g, preferably from 30 to 400 m²/g. As highly dispersible precipitated silicas (referred to as “HD”), mention will be made for example of the silicas Ultrasil 7000 and Ultrasil 7005 from Degussa, the silicas Zeosil 1165MP, 1135MP and 1115MP from Rhodia, the silica Hi-Sil EZ150G from PPG, and the silicas Zeopol 8715, 8745 and 8755 from Huber. Examples of reinforcing aluminas are the aluminas “Baikalox” “A125” or “CR125” from Baikowski, “APA-100RDX” from Condea, “Aluminoxid C” from Degussa or “AKP-G015” from Sumitomo Chemicals.

For coupling the reinforcing inorganic filler to the diene elastomer, as is well-known a coupling agent (or bonding agent) which is at least bifunctional which is intended to provide a sufficient chemical and/or physical connection between the inorganic filler (surface of its particles) and the diene elastomer, in particular bifunctional organosilanes or polyorganosiloxanes, will be used.

Preferably, the amount of total reinforcing filler (carbon black and/or reinforcing inorganic filler) is between 20 and 200 phr, more preferably between 30 and 150 phr, the optimum in known manner being different according to the intended applications.

C) Cross-Linking System

The cross-linking system is preferably a vulcanization system, that is to say a system based on sulfur (or a sulfur donor) and a primary vulcanization accelerator. To this base vulcanization system there are added, incorporated during the first, non-productive phase and/or during the productive phase, both as described later, various known secondary accelerators or vulcanization activators such as zinc oxide, stearic acid or equivalent compounds, or guanidine derivatives (in particular diphenylguanidine).

The sulfur is used in a preferred amount of between 0.5 and 10 phr, more preferably of between 1 and 8 phr, in particular between 1 and 6 phr when the composition of the invention is intended, according to a preferred embodiment of the invention, to constitute an inner tire “rubber” (or rubber composition). The primary vulcanization accelerator is used in a preferred amount of between 0.5 and 10 phr, more preferably of between 0.5 and 5.0 phr.

Any compound capable of acting as a vulcanization accelerator for the diene elastomers in the presence of sulfur, in particular accelerators of the type thiazoles and their derivatives, and accelerators of the type thiurams, zinc dithiocarbamates, can be used as accelerator. These primary accelerators are more preferably selected from the group consisting of 2-mercaptobenzothiazyl disulfide (abbreviated to “MBTS”), N-cyclohexyl-2-benzothiazyl sulfenamide (abbreviated to “CBS”), N,N-dicyclohexyl-2-benzothiazyl sulfenamide (abbreviated to “DCBS”), N-tert-butyl-2-benzothiazyl sulfenamide (abbreviated to “TBBS”), N-tert-butyl-2-benzothiazyl sulfenimide (abbreviated to “TBSI”) and mixtures of these compounds.

D) Lanthanide Compound

It will be recalled that the term “lanthanide ” is reserved for those metals, known as “rare earths”, the atomic number of which varies from 57 (lanthanum) to 71 (lutetium).

Preferably, the lanthanide is selected from the group consisting of lanthanum, cerium, praseodymium, neodymium, samarium, erbium and mixtures of these rare earths. More preferably cerium or neodymium, in particular neodymium, are used.

The lanthanide compound may be of inorganic or organic type.

As examples of inorganic compound, mention may be made in particular of phosphorus-containing derivatives such as for example lanthanide phosphates, in particular neodymium phosphates.

Preferably, an organic lanthanide compound or “organolanthanide” is used, selected in particular from the group consisting of organic salts and derivatives, in particular alcoholates or carboxylates, and also lanthanide complexes. Preferably, the ligands of such complexes contain from 1 to 20 carbon atoms; they are generally selected from the group consisting of o-hydroxyaldehydes, o-hydroxyphenones, hydroxyesters, β-diketones, orthodihydric phenols, alkylene glycols, monocarboxylic acids, dicarboxylic acids and alkylated derivatives of dicarboxylic acids.

Such organolanthanides are preferably selected from the group consisting of abietates, acetates, diethylacetates, acetonates, acetylacetonates, benzoates, butanolates, butyrates, cyclohexane-carboxylates, decanolates, ethylhexanoates, ethylhexanolates, formates, linoleates, maleates, naphthenates, neodecanoates, octanoates, oleates, propanolates, propionates, resinates, stearates, tallates, versatates and mixtures (salts, complexes or other mixed derivatives) of such compounds.

More preferably still, those selected from the group consisting of abietates, acetates, acetylacetonates, benzoates, butyrates, forrnates, linoleates, maleates, oleates, propionates, naphthenates, resinates, stearates, and mixes (salts, complexes or other mixed derivatives) of such compounds are used. Acetylacetonates and naphthenates are the preferred organolanthanides in the majority of cases, more particularly acetylacetonates.

In the composition according to the invention, the amount of lanthanide compound is preferably between 0.1 and 10 phr. Below 0.1 phr, the technical effect desired risks being inadequate, whereas beyond 10 phr there is an increase in cost and the risk of compromising certain mechanical properties of the compositions, both in the initial state and after ageing. For these various reasons, said amount of lanthanide compound is more preferably between 0.2 and 5 phr, even more preferably between 0.5 and 2.5 phr.

It will be recalled that here that the lanthanide compounds, for example neodymium salts such as carboxylates, have hitherto essentially been used as polymerisation catalysts for polymers or elastomers such as dienes (see as examples U.S. Pat. No. 3,803,053, U.S. Pat. No. 5,484,897, U.S. Pat. No. 5,858,903, U.S. Pat. No. 5,914,377, U.S. Pat. No. 6,800,705).

E) Other Constituents

The rubber matrices of the composites according to the invention also comprise all or some of the additives usually used in rubber compositions intended for the manufacture of ground contact systems for motor vehicles, in particular tires, such as for example anti-ageing agents, antioxidants, plasticisers or extender oils, whether the latter be aromatic or non-aromatic in nature, in particular oils which are only very slightly or not aromatic (e.g. naphthenic or paraffinic oils, MES or TDAE oils), agents which facilitate processing of the compositions in the uncured state, a cross-linking system based either on sulfur, or on sulfur and/or peroxide donors, accelerators, vulcanization activators or retarders, anti-reversion agents such as sodium hexathiosulfonate or N,N′-m-phenylene-biscitraconimide, methylene acceptors and donors (for example resorcinol, HMT or H3M) or other reinforcing resins, bismaleimides, other adhesion-promoting systems with regard to metallic reinforcing members, in particular brass-coated ones, such as, for example, those of “RFS” type (resorcinol-formaldehyde-silica) or even other metal salts, such as organic cobalt or nickel salts. The person skilled in the art will be able to adjust the formulation of the composition according to his particular requirements.

To reinforce the performance of the composition and the composite of the invention, one particular embodiment consists of using a bismaleimide compound. This type of compound, which is usable without a curing agent, has curing kinetics which are well suited to those of tires; it is capable of activating the adhesion kinetics and of improving further the endurance under conditions of humid ageing of the adhesive interphases in the composites according to the invention.

It will be recalled that bismaleimides correspond, in known manner, to the following formula: 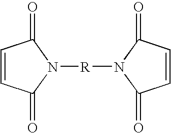
in which R is an aromatic or aliphatic, cyclic or acyclic hydrocarbon radical, whether substituted or non-substituted, such a radical possibly comprising a heteroatom selected from among O, N and S; this radical R preferably comprises from 2 to 24 carbon atoms.

More preferably a bismaleimide is used which is selected from the group consisting of N,N′-ethylene-bismaleimides, N,N′-hexamethylene-bismaleimides, N,N′-(m-phenylene)-bismaleimides, N,N′-(p-phenylene)-bismaleimides, N,N′-(p-tolylene)-bismaleimides, N,N′-(methylenedi-p-phenylene)-bismaleimides, N,N′-(oxydi-p-phenylene)-bismaleimides and mixtures of these compounds. Such bismaleimides are well-known to the person skilled in the art.

In the event that a reinforcing resin or a bismaleimide is used, it is present in the composite of the invention in a preferred amount of between 0.1 and 20%, more preferably between 1 and 8%, by weight of rubber composition. For amounts greater than the maxima indicated, there is a risk of excessive stiffening of the compositions, and hence embrittlement of the composites; for amounts less than the minima indicated, the intended technical effect risks being inadequate.

According to a preferred embodiment of the invention, the composition comprises, in association with the lanthanide compound, at least one cobalt compound in a preferred amount of between 0.1 and 10 phr. It was noted that a certain synergy could exist between the two compounds, resulting in particular in a greater improvement in the adhesive performance under thermal and humid ageing. For the same reasons as indicated previously for the lanthanide compound, the amount of cobalt compound is then more preferably between 0.2 and 5 phr, even more preferably between 0.5 and 2.5 phr.

The cobalt compound is preferably an organic cobalt compound, selected more preferably from the group consisting of abietates, acetates, acetylacetonates, benzoates, butyrates, formates, linoleates, maleates, oleates, propionates, naphthenates, resinates, stearates, and mixtures (that is to say salts, complexes or other mixed derivatives) of such compounds, in particular from among abietates, acetylacetonates, naphthenates, resinates and mixtures of such compounds. Acetylacetonates and naphthenates are preferred in the majority of cases.

F) Preparation of the Rubber Compositions

The compositions are produced in suitable mixers, using two successive preparation phases well-known to the person skilled in the art: a first phase of thermomechanical working or kneading (referred to as “non-productive” phase) at high temperature, up to a maximum temperature of between 110° C. and 190° C., preferably between 130° C. and 180° C., followed by a second phase of mechanical working (referred to as “productive” phase) down to a lower temperature, typically less than 110° C., during which finishing phase the cross-linking system is incorporated.

By way of example, the non-productive phase is effected in a single thermomechanical step lasting several minutes (for example between 2 and 10 min), during which all the base constituents necessary and other additives, with the exception of the cross-linking or vulcanization system, are introduced into a suitable mixer, such as a conventional internal mixer. After cooling the mixture thus obtained, the vulcanization system is then incorporated in an external mixer such as an open mill, kept at low temperature (for example between 30° C. and 100° C.). The whole is then mixed (productive phase) for several minutes, (for example between 5 and 15 min).

The final composition thus obtained can then be calendered, for example in the form of a film or a sheet, or alternatively extruded, for example in order to form a rubber profiled element used for manufacturing a composite or a semi-finished product, such as, for example, plies, treads, underlayers, other rubber blocks reinforced by metallic reinforcing members, intended to form for example part of the structure of a tire.

The vulcanization (or curing) can then be carried out in known manner at a temperature generally of between 130° C. and 200° C., preferably under pressure, for a sufficient time which may vary for example between 5 and 90 min according in particular to the curing temperature, the vulcanization system adopted and the vulcanization kinetics of the composition in question.

The invention relates to the rubber compositions and composites, both in the “uncured” state (i.e. before curing) and in the “cured” or vulcanized state (i.e. after vulcanization).

II-2. Metallic Reinforcing Member

“Metallic reinforcing member” is to be understood to mean any reinforcement element capable of reinforcing the rubber matrix, be it entirely metallic or not, at least the surface or outer part of which, which is intended to come into contact with the rubber, is made of metal.

This reinforcing member may be in different forms, preferably in the form of a unitary cord (unit cord), a film (for example a strip or band) or an assembly of cords, whether these cords be twisted together (for example, in the form of a cable) or essentially parallel to each other (for example in the form of a bundle of cords, a continuous fibre or alternatively an assembly of short fibres).

In the composites and tires of the invention, this reinforcing member is more preferably in the form of a unitary cord or an assembly of cords, for example a cable or a strand manufactured with cabling or stranding devices and processes known to the person skilled in the art, which are not described here in order to simplify the description.

The metal, or surface metal if applicable, of the metallic reinforcing member is preferably selected from among Fe, Cu, Zn, Al, Sn, Ni, Co, Cr, Mn, and oxides, hydroxides and alloys of these elements, more preferably from among Fe, Cu, Zn, Al, Sn and their oxides, hydroxides and alloys.

Preferably a steel reinforcing member, in particular one made of perlitic (or ferrito-perlitic) carbon steel referred to in known manner as “carbon steel”, or alternatively of stainless steel, such as are described for example in patent applications EP-A-648 891 or WO98/41682, is used. However, it is of course possible to use other steels or other alloys.

When a carbon steel is used, its carbon content is preferably of between 0.1% and 1.2%, in particular between 0.5% and 1.1% (% by weight of steel); it is more preferably of between 0.6% and 1.0%, such a content representing a good compromise between the mechanical properties required for the tire and the feasibility of the wires.

The person skilled in the art is able to adapt the composition of the steel according to his own particular needs, using for example micro-alloyed carbon steels containing specific alloying elements such as Cr, Ni, Co, V, or various other known elements (see for example Research Disclosure 34984—“Micro-alloyed steel cord constructions for tires”—May 1993; Research Disclosure 34054—“High tensile strength steel cord constructionsfor tires”—August 1992).

As indicated previously, the metal or steel used, be it in particular a carbon steel or a stainless steel, may be used “as is” (what is called “bright” steel) or itself be coated with an additional metallic layer which improves for example the processing properties of the metallic reinforcing member and/or its constituent elements, or the use properties of the reinforcing member and/or of the composite themselves.

According to a preferred embodiment, the steel used, in particular when it is a carbon steel, is covered by an additional layer of metal selected from among aluminium, zinc, copper and binary or ternary alloys of these metals.

Of the alloys of aluminium, preferably those selected from among the binary alloys Al—Mg, Al—Cu, Al—Ni, Al—Zn and ternary alloys of Al and two of the elements Mg, Cu, Ni, Zn, more particularly an Al—Zn alloy, are used.

Of the alloys of zinc, preferably those selected from among the binary alloys Zn—Cu, Zn—Al, Zn—Mn, Zn—Co, Zn—Mo, Zn—Fe, Zn—Ni, Zn—Sn and ternary alloys of Zn and two of the elements (for example Zn—Cu—Ni or alternatively Zn—Cu—Co), more particularly a Zn—Cu alloy (brass) or a Zn—Al alloy as mentioned above, are used.

Of the alloys of copper, the preferred binary alloys are those of Cu—Zn (brass as mentioned above) and Cu—Sn (bronze).

When an additional metallic layer is laid on the metallic reinforcing member or on the individual constituent elements of this reinforcing member, in particular when it is an assembly, any deposition process which is capable of applying, continuously or discontinuously, a metal coating to a metal substrate may be used. For example, a simple technique of continuous dipping, in a bath containing the metal or alloy in the molten state, a technique of deposition by electrolysis or alternatively by a spraying process, is used.

In the most frequent case in which the reinforcing member used is a cable formed of fine cords, the additional metallic layer will preferably be deposited on the cords, not on the final cable. In such a case, in particular to facilitate the drawing operations, the deposition will be advantageously effected on a wire of what is called an “intermediate” diameter, for example of the order of one millimetre, upon emerging from the last heat treatment (patenting) preceding the final wet drawing stage to obtain the fine wire having the intended final diameter.

When the composites of the invention are used to reinforce carcass or crown reinforcements for radial tires, the reinforcing members used are preferably assemblies (strands or cables) of fine wires of carbon steel or of stainless steel having:
a tensile strength greater than 2000 MPa, more preferably greater than 2500 MPa, in particular greater than 3000 MPa; the person skilled in the art will know how to manufacture fine wires having such strength, by adjusting in particular the composition of the steel and the final work-hardening ratios of these wires;
for a good compromise of strength/flexural strength/feasibility, a diameter φ of between 0.10 and 0.40 mm, more preferably between 0.10 and 0.30 mm approximately when the composite is intended to reinforce a carcass reinforcement, between 0.20 and 0.40 mm approximately when the composite is intended to reinforce a crown reinforcement.

When the composites of the invention are used to reinforce bead zones of tires, the reinforcing members may be in particular in the form of bead wires formed of carbon steel or stainless steel wires, whether unitary or assembled ones, these wires having:
a tensile strength greater than 1500 MPa, more preferably greater than 2000 MPa;
a diameter 4 (or a characteriztic dimension, if it is a wire which is other than cylindrical) of between 0.5 and 3 mm, more preferably between 0.8 and 2.2 mm.
   II-3. Composite and Tire of the Invention

The rubber composition of the invention and the metallic reinforcing member which have been previously described are usable for manufacturing a metal/rubber composite which constitutes another subject of the invention, in which composite the adhesion between the metal and the rubber is provided due to the use of the lanthanide compound in said composition.

This composite may be present in varied forms, for example in the form of a ply, a band, strip or a block of rubber in which the metallic reinforcing member is incorporated, or alternatively a rubber wrap coating the metallic reinforcing member, the latter being in direct contact with the rubber composition. The definitive adhesion between the metal and the rubber composition can be obtained on emerging from the curing of the finished article comprising the composite; preferably this curing is effected under pressure.

The composites according to the invention are preferably intended for tires, in particular radial tires, to form all or part of the crown reinforcement, the carcass reinforcement or the reinforcement of the bead zone of such tires.

By way of example, the appended figure depicts very diagrammatically a radial section through a tire 1 having a radial carcass reinforcement in accordance with the invention, intended equally well for a heavy vehicle or a passenger vehicle in this general representation.

This tire 1 comprises a crown 2, two sidewalls 3, two beads 4 and a carcass reinforcement 7 extending from one bead to the other. The crown 2, which is surmounted by a tread (not shown in this diagram, for purposes of simplification) is in known manner reinforced by a crown reinforcement 6 formed for example of at least two superposed crossed crown plies (what are called “working” crown plies), possibly covered by at least one protective ply or zero-degree wrapping crown ply. The carcass reinforcement 7 is wound around the two bead wires 5 within each bead 4, the upturn 8 of this reinforcement 7 being for example arranged towards the outside of the tire 1, which is shown here mounted on its rim 9. The carcass reinforcement 7 is formed of at least one ply reinforced by what are called “radial” cables, that is to say that these cables are arranged practically parallel to each other and extend from one bead to the other so as to form an angle of between 80° and 90° with the median circumferential plane (plane perpendicular to the axis of rotation of the tire which is located halfway between the two beads 4 and passes through the centre of the crown reinforcement 6).

Of course, this tire 1 furthermore comprises in known manner an internal rubber or elastomer layer (commonly referred to as “internal rubber”) which defines the radially inner face of the tire and which is intended to protect the carcass ply from the diffusion of air coming from the interior of the tire. Advantageously, in particular in the case of a tire for a heavy vehicle, it may furthermore comprise an intermediate elastomer reinforcement layer which is located between the carcass ply and the inner layer, intended to reinforce the inner layer and, consequently, the carcass reinforcement, and also intended partially to delocalise the forces to which the carcass reinforcement is subjected.

The tire according to the invention has the essential characteriztic of comprising in its structure at least one metal/rubber composite according to the invention, this composite possibly being, for example, part of the bead zone 4 comprising the bead wire 5, a crossed crown ply or a protective ply for the crown reinforcement 6, or a ply forming all or part of the carcass reinforcement 7.

As indicated previously, the composite of the invention can advantageously be used in crown reinforcements for all types of tires, for example for passenger vehicles, vans or heavy vehicles. Preferably, in such a case, the rubber composition of the invention has, in the vulcanized state (i.e. after curing), a modulus E10 which is greater than 4 MPa, more preferably of between 6 and 20 MPa, for example between 6 and 15 MPa.

However, the composite of the invention may have a use which is equally advantageous in a carcass reinforcement for a tire for an industrial vehicle such as a heavy vehicle. Preferably, in such a case, the rubber composition of the invention has, in the vulcanized state, a modulus E10 which is less than 9 MPa, more preferably of between 4 and 9 MPa.

III. Examples of Embodiment of the Invention

III-1. Preparation of the Rubber Compositions

For the following tests, the procedure is as follows: the diene elastomer (or the mixture of diene elastomers, if applicable), the reinforcing filler and the various other ingredients, with the exception of the vulcanization system, are introduced into an internal mixer filled to 70%, the initial tank temperature of which is approximately 60° C. Thermomechanical working (non-productive phase) is then performed in a single step (total duration of kneading equal for example to about 7 minutes), until a maximum “dropping” temperature of about 165-170° C. is reached. The mixture thus obtained is recovered, it is cooled and then the vulcanization system (sulfur and sulfenamide accelerator) is added on an external mixer (homo-finisher) at 30° C., by mixing everything (productive phase) for example for 3 to 10 minutes.

The compositions thus obtained are then either extruded in the form of thin slabs (thickness of 2 to 3 mm) in order to measure their physical or mechanical properties, or calendered in order to produce a metallic cabled fabric forming part of the crown reinforcement of a passenger-car tire.

In the following tests, eight different rubber compositions or matrices, M-1 to M-8, based on natural rubber and carbon black, having after curing a modulus E10 of between 8 and 12 MPa (approximately 11 MPa for the compositions M-1 to M-4 and approximately 9 MPa for the matrices M-5 to M-8), are used.

The formulations of these compositions are shown in the appended Tables 1 and 2. They essentially comprise, in addition to the elastomer and the reinforcing filler, a paraffin oil, an antioxidant, zinc oxide, stearic acid, sulfur and a sulfenamide accelerator, for some of them (M-1 to M-4) a reinforcing resin (phenolic resin plus methylene donor), and finally a metal/rubber adhesion promoter comprising either a cobalt compound alone for the control compositions (M-1 and M-5), or a cobalt compound and a lanthanide compound for the compositions according to the invention (M-2 to M-4, M-6 to M-8).

III-2. Metallic Reinforcing Members

Cables formed of fine carbon steel wires, coated with brass, suitable for reinforcing crown reinforcements of passenger-vehicle tires, are used.

The fine wires of carbon steel are prepared starting, for example, from machine wires (diameter 5 to 6 mm) which are first of all work-hardened, by rolling and/or drawing, to an intermediate diameter close to 1 mm, or alternatively starting directly from commercial intermediate wires, the diameter of which is close to 1 mm. The steel used is a known carbon steel, for example of the type USA AISI 1069, the carbon content of which is approx. 0.8%, comprising approximately 0.5% manganese, the remainder consisting of iron and the usual inevitable impurities linked to the manufacturing process for the steel (for example, contents of silicon: 0.25%; phosphorus: 0.01%; sulfur: 0.01%; chromium: 0.11%; nickel: 0.03%; copper: 0.01%; aluminium: 0.005%; nitrogen: 0.003%). The wires of intermediate diameter then undergo a degreasing and/or pickling treatment, before their subsequent transformation. After depositing a brass or zinc coating on these intermediate wires, what is called “final” work-hardening is effected on each wire (i.e. performed after the final heat treatment of patenting), by cold-drawing in a wet medium with a drawing lubricant which is for example in the form of an aqueous emulsion or dispersion.

The cables used are cables of known structure [1+2], non-wrapped, and formed of 3 wires of a diameter of approximately 0.26 mm (Fm=180 N; Rm=3200 MPa; At=2.3%); these cables comprise a single, straight core wire, around which are wound together in a helix (S direction) two other wires in a pitch of 12 mm. Each carbon steel wire is coated with a layer of brass (64% of copper and 36% of zinc). The brass coating has a very low thickness, significantly less than one micrometre, which is equivalent to approximately 0.35 to 0.40 g of brass per 100 g of wire. The mechanical properties of these cables are as follows: Fm=480 N; Rm=3000 MPa; At=2.7%.

III-3. Composites—Adhesion Tests

8 carbon steel/rubber composites, designated C-1 to C-8 respectively, being in the form of blocks of rubber intended for the adhesion test described in section I-2 above are prepared by calendering from the 8 rubber matrices M-1 to M-8 and the metallic reinforcing members previously described.

A) Test 1

In this first test the adhesive performance of composites C-1 to C-4 subjected to the “thermal ageing” conditions are compared.

Composite C-1 is the control comprising a conventional rubber matrix and furthermore comprising a reinforcing resin and a cobalt compound as adhesion promoter (matrix M-1). Composites C-2 to C-4, all three in accordance with the invention, are distinguished only by the additional presence of an organolanthanide (neodymium, cerium or samarium) in their rubber matrix (M-2 to M-4).

The results obtained in the adhesion test are summarised in the appended Table 3, in relative units (r.u.), the base 100 being used for the initial tearing force (directly after curing) recorded on the control composite.

It will be noted first of all that the composites according to the invention all exhibit an initial adhesion (tearing force Fa) which is slightly greater than that of the control (C-1) which is however characterized by an initial level of adhesion which is very high (of the order of 30 daN) for the composite in question.

After thermal ageing, it is observed that the tearing force Fa of the control composite is reduced by half, whereas it unexpectedly undergoes only a slight adverse change for the composites of the invention, not exceeding approximately 25%, to within the accuracy of measurement, relative to the reference value. The better result is obtained here with the organic cerium compound (composite C-3), which offers an adhesion which is slightly improved in the initial state (+4%) and which is practically not compromised after thermal ageing, which is noteworthy compared with the control composite C-1.

The addition of the organolanthanide compound therefore makes it possible to improve slightly the initial adhesion and to increase considerably the adhesive performance after thermal ageing.

B) Test 2

To confirm the beneficial effect of the invention, in this test the adhesive performance of the composites C-5 to C-8 subjected this time to the conditions of “thermal and humid ageing” is compared. Composite C-5 is the control comprising a conventional rubber matrix containing in particular a cobalt compound as adhesion promoter and furthermore devoid of reinforcing resin (matrix M-5). Composites C-6 to C-8, all three in accordance with the invention, are distinguished only by the additional presence of organolanthanide (neodymium, cerium or samarium) in their rubber matrix (M-6 to M-8).

The results obtained are summarised in the appended Table 4, in relative units (base 100 for the initial force Fa recorded on the control composite C-5).

It will be noted that the initial level of adhesion is always very high, whatever the composite in question. After ageing, it is noted that the tearing force Fa of the control composite is reduced by 65%, whereas it undergoes comparatively only a very slight adverse change, not exceeding approximately 25%, for the composites of the invention, despite severe ageing. The best result is observed on composite C-7 (cerium), with an improved adhesion of more than 20% in the initial state, which is notable, and, as for the previous test, virtually not affected relative to the control composite (C-5).

Supplementary adhesion tests, performed on the same metallic reinforcing members and similar rubber matrices, have furthermore revealed that the composites comprising the lanthanide compound (2 or 4 phr of neodymium or samarium acetylacetonate) instead of the cobalt salt as the sole adhesion promoter, after thermal and humid ageing exhibited residual adhesive forces (tearing) 1.5 to 2.0 times greater than when using the cobalt salt.

In summary, the foregoing tests clearly demonstrate that organic lanthanide salts are very effective promoters of adhesion between metal and rubber and allow a significant increase in the life of the metal/rubber composites, and therefore of the tires comprising them, after ageing of thermal type, in particular in humid conditions.

TABLE 1

| Rubber composition: | M-1 | M-2 | M-3 | M-4 |
|---|---|---|---|---|
| diene elastomer (1) | 100 | 100 | 100 | 100 |
| carbon black (2) | 55 | 55 | 55 | 55 |
| antioxidant (3) | 1.5 | 1.5 | 1.5 | 1.5 |
| plasticiser (paraffin oil) | 2 | 2 | 2 | 2 |
| zinc oxide | 8 | 8 | 8 | 8 |
| stearic acid | 0.6 | 0.6 | 0.6 | 0.6 |
| methylene acceptor (4) | 1.0 | 1.0 | 1.0 | 1.0 |
| methylene donor (5) | 0.5 | 0.5 | 0.5 | 0.5 |
| cobalt compound (6) | 1.0 | 1.0 | 1.0 | 1.0 |
| neodymium acetylacetonate (7) | — | 1.0 | — | — |
| cerium acetylacetonate (8) | — | — | 1.0 | — |
| samarium acetylacetonate (9) | — | — | — | 1.0 |
| sulfur | 4.5 | 4.5 | 4.5 | 4.5 |
| sulfenamide (10) | 0.8 | 0.8 | 0.8 | 0.8 |

(1) natural rubber;
(2) N330 (name in accordance with Standard ASTM D-1765);
(3) N-(1,3-dimethylbutyl)-N′-phenyl-p-phenylenediamine; (“Santoflex 6-PPD” from Flexsys);
(4) resorcinol (from Sumitomo);
(5) HMT (hexamethylenetetramine - from Degussa);
(6) cobalt naphthenate (Sigma-Aldrich - product No. 544574);
(7) C₁₅H₂₁NdO₆•xH₂O (Sigma-Aldrich - product No. 460427);
(8) C₁₅H₂₁CeO₆•xH₂O (Sigma-Aldrich - product No. 381403);
(9) C₁₅H₂₁SmO₆•xH₂O (Sigma-Aldrich - product No. 517666);
(10) N-dicyclohexyl-2-benzothiazole-sulfenamide (“Santocure CBS” from Flexsys).

TABLE 2

| Rubber composition: | M-5 | M-6 | M-7 | M-8 |
|---|---|---|---|---|
| diene elastomer (1) | 100 | 100 | 100 | 100 |
| carbon black (2) | 55 | 55 | 55 | 55 |
| antioxidant (3) | 1.5 | 1.5 | 1.5 | 1.5 |
| plasticiser (paraffin oil) | 2 | 2 | 2 | 2 |
| zinc oxide | 8 | 8 | 8 | 8 |
| stearic acid | 0.6 | 0.6 | 0.6 | 0.6 |
| cobalt compound (4) | 1.0 | 1.0 | 1.0 | 1.0 |
| neodymium acetylacetonate (5) | — | 1.0 | — | — |
| cerium acetylacetonate (6) | — | — | 1.0 | — |
| samarium acetylacetonate (7) | — | — | — | 1.0 |
| sulfur | 4.5 | 4.5 | 4.5 | 4.5 |
| sulfenamide (8) | 0.8 | 0.8 | 0.8 | 0.8 |

(1) natural rubber;
(2) N330 (name in accordance with Standard ASTM D-1765);
(3) N-(1,3-dimethylbutyl)-N′-phenyl-p-phenylenediamine; (“Santoflex 6-PPD” from Flexsys);
(4) cobalt naphthenate (Sigma-Aldrich - product No. 544574);
(5) C₁₅H₂₁NdO₆•xH₂O (Sigma-Aldrich - product No. 460427);
(6) C₁₅H₂₁CeO₆•xH₂O (Sigma-Aldrich - product No. 381403);
(7) C₁₅H₂₁SmO₆•xH₂O (Sigma-Aldrich - product No. 517666);
(8) N-dicyclohexyl-2-benzothiazole-sulfenamide (“Santocure CBS” from Flexsys).

TABLE 3

| | Fa (r.u.) | Fa (r.u.) |
|---|---|---|
| Composite | in the initial state | after thermal ageing |
| C-1 (control) | 100 | 48 |
| C-2 (invention) | 110 | 74 |
| C-3 (invention) | 104 | 96 |
| C-4 (invention) | 107 | 85 |

TABLE 4

| | | Fa (r.u.) |
|---|---|---|
| | Fa (r.u.) | after thermal ageing |
| Composite | in the initial state | under wet conditions |
| C-5 (control) | 100 | 35 |
| C-6 (invention) | 94 | 74 |
| C-7 (invention) | 122 | 96 |
| C-8 (invention) | 99 | 92 |

1. A rubber composition usable for manufacturing a metal/rubber composite and capable of adhering to a metallic reinforcing member, comprising at least one diene elastomer, a reinforcing filler, a cross-linking system and a lanthanide compound.

2. The composition according to claim 1, wherein the diene elastomer is selected from the group consisting of polybutadienes, natural rubber, synthetic polyisoprenes, butadiene copolymers, isoprene copolymers and mixtures of these elastomers.

3. The composition according to claim 2, wherein the diene elastomer is selected from the group consisting of natural rubber, synthetic polyisoprenes, isoprene copolymers and mixtures of these elastomers.

4. The composition according to claim 3, wherein the diene elastomer is natural rubber or a synthetic polyisoprene having an amount of cis-1,4 bonds greater than 90% (mole %).

5. The composition according to claim 4, wherein the diene elastomer is a synthetic polyisoprene having an amount of cis-1,4 bonds greater than 98% (mole %).

6. The composition according to claim 1, wherein the reinforcing filler is carbon black.

7. The composition according to claim 1, wherein the reinforcing filler is a reinforcing inorganic filler.

8. The composition according to claim 7, wherein the reinforcing inorganic filler is silica.

9. The composition according to claim 1, wherein the amount of reinforcing filler is between 20 and 200 phr.

10. The composition according to claim 9, wherein the amount of reinforcing filler is between 30 phr and 150 phr.

11. The composition according to claim 1, wherein the crosslinking system is based on sulfur and an accelerator.

12. The composition according to claim 11, wherein the accelerator is a sulfenamide accelerator.

13. The composition according to claim 12, wherein the amount of sulfenamide accelerator is between 0.5 and 10 phr.

14. The composition according to claim 13, wherein the amount of sulfenamide accelerator is between 0.5 and 5.0 phr.

15. The composition according to claim 11, wherein the amount of sulfur is between 0.5 and 10 phr.

16. The composition according to claim 15, wherein the amount of sulfur is between 1 and 8 phr.

17. The composition according to claim 1, wherein the lanthanide is selected from the group consisting of lanthanum, cerium, praseodymium, neodymium, samarium, erbium and mixtures of these rare earths.

18. The composition according to claim 17, wherein the lanthanide is neodymium.

19. The composition according to claim 1, wherein the lanthanide compound is an organolanthanide.

20. The composition according to claim 19, wherein the organolanthanide is selected from the group consisting of abietates, acetates, acetylacetonates, benzoates, butyrates, formates, linoleates, maleates, oleates, propionates, naphthenates, resinates, stearates, and mixtures of such compounds.

21. The composition according to claim 20, wherein the organolanthanide is neodymium acetylacetonate.

22. The composition according to claim 1, wherein the amount of lanthanide compound is between 0.1 and 10 phr.

23. The composition according to claim 22, wherein the amount of lanthanide compound is between 0.2 and 5 phr.

24. The composition according to claim 1, wherein said composition furthermore comprises a cobalt compound.

25. The composition according to claim 24, wherein the cobalt compound is selected from the group consisting of abietates, acetylacetonates, naphthenates, resinates and mixtures of such compounds.

26. The composition according to claim 25, wherein the amount of cobalt compound is between 0.1 and 10 phr.

27. The composition according to claim 26, wherein the amount of cobalt compound is between 0.2 and 5 phr.

28.-37. (canceled)

38. A metal/rubber adhesion-promoting system, comprising a lanthanide compound and a cobalt compound in combination.

39. The system according to claim 38, wherein the lanthanide compound is an organolanthanide.

40. The system according to claim 39, wherein the organolanthanide is selected from the group consisting of abietates, acetates, acetylacetonates, benzoates, butyrates, formates, linoleates, maleates, oleates, propionates, naphthenates, resinates, stearates, and mixtures of such compounds.

41. The system according to claim 40, wherein the organolanthanide is neodymium acetylacetonate.

42. The system according claim 38, wherein the cobalt compound is selected from among abietates, acetylacetonates, naphthenates, resinates and mixtures of such compounds.

43. A metal/rubber composite comprising a diene rubber composition according to claim 1 and at least one metallic reinforcing member adhering to said rubber composition.

44. The composite according to claim 43, wherein the metal of the metallic reinforcing member is steel.

45. The composite according to claim 44, wherein the steel is a carbon steel or a stainless steel.

46. The composite according to claim 45, wherein the steel is a carbon steel having a carbon content of between 0.2% and 1.2%.

47. The composite according to claim 46, wherein the steel is a carbon steel having a carbon content of between 0.5% and 1.1%.

48. The composite according to claim 44, wherein the steel is coated with a layer of brass.

49.-53. (canceled)

54. A ground contact system or semi-finished product made of rubber incorporating a composite according to claim 43.

55. The ground contact system according to claim 54, wherein said system consists of a tire.

56. The tire according to claim 55, wherein the composite is present in the reinforcement of the bead zone of the tire.

57. The tire according to claim 55, wherein the composite is present in the carcass reinforcement of the tire.

58. The tire according to claim 57, wherein the rubber composition of the composite has, in the vulcanized state, a secant tensile modulus, at 10% elongation, which is less than 9 MPa.

59. The tire according to claim 58, wherein the rubber composition of the composite has, in the vulcanized state, a secant tensile modulus, at 10% elongation, which is between 4 and 9 Mpa.

60. The tire according to claim 55, wherein the composite is present in the crown reinforcement of the tire.

61. The tire according to claim 60, wherein the rubber composition of the composite has, in the vulcanized state, a secant tensile modulus, at 10% elongation, which is greater than 4 Mpa.

62. The tire according to claim 61, wherein the rubber composition of the composite has, in the vulcanized state, a secant tensile modulus, at 10% elongation, which is between 4 and 20 MPa.

63. The composition according to claim 19, wherein the organolanthanide is selected from the group consisting of acetylacetonates and naphthenates, and mixtures of such compounds.

64. The composition according to claim 22, wherein the amount of lanthanide compound is between 0.2 and 5 phr.

65. A composition according to claim 26, wherein the amount of cobalt compound is between 0.2 and 2.5 phr.

66. The system according to claim 39, wherein the organolanthanide is selected from the group consisting of acetylacetonates and naphthenates, and mixtures of such compounds.

67. The composite according to claim 46, wherein the steel is a carbon steel having a carbon content of between 0.6% and 1.0%.
